(19) United States
(12) Patent Application Publication
(10) Pub. No.: US 2026/0145793 A1
(43) Pub. Date: May 28, 2026

(54) PASSENGER SUPPLY SYSTEM AND AIRCRAFT EQUIPPED WITH A PASSENGER SUPPLY SYSTEM

(71) Applicant: Airbus Operations GmbH, HAMBURG (DE)

(72) Inventor: Hendrik SEGELHORST, HAMBURG (DE)

(21) Appl. No.: 19/400,350

(22) Filed: Nov. 25, 2025

(30) Foreign Application Priority Data
Nov. 27, 2024 (DE) 102024134990.5

(51) Int. Cl. B64D 11/00

(52) U.S. Cl. CPC B64D 11/003

(57) ABSTRACT

A passenger supply system for an aircraft. The passenger supply system has a passenger supply channel, a passenger service unit having a main body, and an infill panel. A portion of the main body of the passenger service unit overlaps an end of the infill panel. Also an aircraft with such a passenger supply system.

### CROSS-REFERENCES TO RELATED APPLICATIONS

This application claims the benefit of German Patent Application Number 10 2024 134 990.5 filed on Nov. 27, 2024, the entire disclosure of which is incorporated herein by way of reference.

### FIELD OF THE INVENTION

The present disclosure generally relates to a passenger supply system. Particularly, the present disclosure relates to a passenger supply system having a passenger supply channel with a passenger service unit arranged therein, the passenger service unit overlapping an infill panel also arranged in the passenger supply channel. The present disclosure further relates to an aircraft having such passenger supply system.

### BACKGROUND OF THE INVENTION

A conventional passenger supply system having a passenger supply channel (PSC) allows arrangement of a plurality of passenger service units (personal units providing reading lights, fresh air nozzles, oxygen masks and the like for one or more passengers sitting below a respective one of the passenger service units). The passenger service units (PSUs) are arranged in the passenger supply channel with a spacing in a longitudinal direction of the PSC (i.e., a distance between two adjacent PSUs) corresponding to or at least associated with a longitudinal spacing between two adjacent seat rows.

The spacing (distance) between the two adjacent seat rows can be changed, for instance, when the operator of the aircraft wants to increase or decrease the number of seats in the aircraft. In such cases, the spacing (distance) between the corresponding PSUs is to be changed as well. Thus, one or more infills are provided to close or cover the PSC in an area between the PSUs. Such infills are available in different sizes in the longitudinal direction of the PSC, so that a combination of differently sized infills can be used to fill any gap in the PSC between adjacent PSUs.

However, the passenger supply system still has possibilities for improvement.

### SUMMARY OF THE INVENTION

It is therefore an object of the present disclosure to provide an improved passenger supply system.

This object may be solved by the present invention as described in the various embodiments herein.

According to a first aspect to better understand the present disclosure, a passenger supply system for an aircraft comprises a passenger supply channel, a passenger service unit having a main body, wherein the passenger service unit is configured to be mounted into the passenger supply channel, and an infill panel configured to be mounted into the passenger supply channel.

Moreover, a portion of the main body of the passenger service unit overlaps an end of the infill panel. In other words, the main body of the passenger service unit (PSU) has a portion or section that extends in the direction of the infill panel and overlaps the infill panel. Particularly, the portion of the main body covers the infill panel on a side/surface of the infill facing away from the passenger supply channel (PSC), such as the side/surface facing towards the passengers, for example, facing downwards.

This allows the provision of an infill panel (in the present disclosure also simply referred to as an infill) having a size/dimension in the longitudinal direction of the PSC that may leave a gap between the infill and a section of the PSU in the PSC. Therefore, the number of differently sized infills can be reduced, which simplifies the installation and change of passenger supply systems. For instance, the number of different infills to be produced, stored and provided to the aircraft can be reduced. Since each component in an aircraft has to be officially certified for use in an aircraft, the passenger supply system requires a reduced number of certified components.

In an implementation variant, the passenger supply channel can face downwards in a vertical direction and can have a bottom edge. In other words, the PSC is arranged at the bottom side of an interior component of the aircraft, such as an overhead stowage compartment or a ceiling in the cabin of the aircraft. Thus, a PSU installed in the PSC faces towards the passengers sitting underneath the PSC. The bottom edge delimits one side of an opening of the PSC.

Furthermore, the portion of the main body overlapping the infill panel can be arranged below the bottom edge of the passenger supply channel. In other words, the PSU, particularly the portion of the main body overlapping with the infill panel, may extend further into the passenger cabin (in a downwards direction) than a bottom surface of the infill panel. Thus, instead of installing the PSU entirely in the PSC and facilitating a flush look with the infill panels, the PSU protrudes a small amount from the PSC. This may mean a small aesthetical change of the passenger supply system, but comes with the advantage of covering possible irregularities or unfinished edges of adjacent infill panels.

In an implementation variant, an entire bottom portion of the main body of the passenger service unit can be arranged below the bottom edge. Thus, the main body can have a substantially plane bottom surface (below the bottom edge of the PSC), which allows a decent aesthetical impression of the PSU.

In an implementation variant, a circumference of the main body can overlap a first infill panel, a second infill panel and the respective bottom edge on both sides of the passenger services channel. In other words, along a circumference of the main body the surrounding components are covered by the PSU, particularly the portion of its main body. Thus, any edge of the infill panels and the PSC are covered by the portion of the main body which can improve the look of the passenger supply system.

In an implementation variant, the portion of the main body overlapping the infill panel can be chamfered. Thus, the PSU does not have the look of a brick-like component, but integrates into the overall aesthetic impression of the passenger supply system. Particularly, the chamfer formed by the outer circumference of the main body is towards a plane defined by the bottom edge of the PSC and/or the bottom surface of the infill panel.

In an implementation variant, passenger supply system can further comprise a light source arranged at a top surface of the main body. The top surface faces upwards in a vertical direction, when the PSU is installed in the PSC. Thus, the top surface is actually not visible from the passenger cabin, as it faces away from a passenger area.

In an implementation variant, the light source can be arranged at a circumference of the main body. Thus, it is possible that the light emitted by the light source illuminates the outer edge (circumferential edge) of the main body or at least a portion thereof. Therefore, the PSU, according to the present disclosure, allows for additional light effects and illumination of the passenger cabin.

In an implementation variant, the light source can indicate a passenger call. As the PSU is regularly associated with one or more passenger seats, the light source of the PSU can be employed to indicate to a flight attendant that a passenger call has been initiated at the one or more passenger seats. As a mere example, the light source can simply be switched on in case of a passenger call. Alternatively, the light source can change a color of the emitted light in case of a passenger call, which allows also using the light source for a general illumination (effect) of the passenger cabin.

In an implementation variant, the passenger supply system further comprises a further passenger service unit mounted in the passenger supply channel at a distance in a longitudinal direction of the passenger supply channel. In other words, the further passenger service unit is associated with or corresponds to another passenger seat or seat row. The distance between both PSUs corresponds to the distance between the respective passenger seats or seat rows or is at least dependent therefrom.

Furthermore, the infill panel can have a length in the longitudinal direction of the passenger supply channel corresponding to the distance between the passenger service units. Thus, it is possible to provide a single infill panel, which avoids the conventional arrangement of a plurality of infill panels having different sizes (particularly different lengths) and significantly increases the aesthetic impression and look of the passenger cabin. As a mere example, when using a plurality of infill panels, they may move in a transverse direction perpendicular to the longitudinal direction of the PSC, so that the side edges of the infill panels are not flush (not in a line) anymore. This is regularly visible, as the bottom edge of the PSC or associated linings arranged next to the PSC have a continuous edge.

Due to the overlap with the portion of the main body of each of the PSUs, the infill panel can be provided with a standard length, irrespective of the arrangement of the PSUs in the PSC.

In an implementation variant, the infill panel can be provided with a standard length corresponding to the largest possible distance between two adjacent PSUs. Thus, only a single certified part has to be provided to build any passenger supply system in any aircraft. In case of a reduced distance between two adjacent PSUs, the standard-length infill panel can simply be cut. The cut edge will be covered by the portion of the main body of the PSU, so that the provision and installation of the cut infill panel does not require additional time.

In an implementation variant, a longitudinal end of the infill panel can be machined after cutting the infill panel to have the length.

In an implementation variant, the infill panel can be an extruded profile. As a mere example, the extruded infill panel can be made from a plastic material.

According to a second aspect to better understand the present disclosure, an aircraft comprises at least one passenger supply system of the first aspect or one or more of its variants.

In an implementation variant, the aircraft can further comprise a plurality of overhead stowage compartments. The passenger supply channel of the at least one passenger supply system is arranged at a bottom (aside) of the plurality of overhead stowage compartments.

According to a third aspect to better understand the present disclosure, a method of installing a passenger supply system in an aircraft comprises the steps of:
providing a plurality of passenger service units of a passenger supply system, according to the first aspect or one or more of its variants;
providing a single infill panel having a standard length;
cutting the single infill panel to a length corresponding to a length of a gap between two adjacent passenger service units along the passenger supply channel;
installing the cut infill panel in the passenger supply channel; and
installing one of the plurality of passenger service units at each longitudinal end of the installed infill panel, wherein the portion of the main body of each passenger service unit overlaps (covers) the respective longitudinal end (or edge) of the installed infill panel.

In an implementation variant, the providing of the single infill panel comprises manufacturing the infill panel by extrusion.

The present disclosure is not restricted to the aspects and variants in the described form and order. Specifically, the description of aspects and variants is not to be understood as a specific limiting grouping of features. It is to be understood that the present disclosure also covers combinations of the aspects and variants. Thus, each variant or optional feature can be combined with any other aspect, variant, optional feature or even combinations thereof.

### BRIEF DESCRIPTION OF THE DRAWINGS

In the following, the present disclosure will further be described with reference to exemplary implementations illustrated in the figures, in which:

FIG. 1 schematically illustrates a conventional passenger supply system;

FIG. 2 schematically illustrates an exemplary passenger service unit;

FIG. 3 schematically illustrates an exemplary passenger supply channel having the passenger service unit of FIG. 2 installed therein;

FIG. 4 schematically illustrates another exemplary passenger service unit;

FIG. 5 schematically illustrates another exemplary passenger supply channel having the passenger service unit of FIG. 4 installed therein; and

FIG. 6 schematically illustrates an aircraft comprising a passenger supply system, and a cross-sectional view of the passenger supply system.

### DETAILED DESCRIPTION OF THE PREFERRED EMBODIMENTS

In the following description, for purposes of explanation and not limitation, specific details are set forth in order to provide a thorough understanding of the present disclosure. It will be apparent to one skilled in the art that the present disclosure may be practiced in other implementations that depart from these specific details.

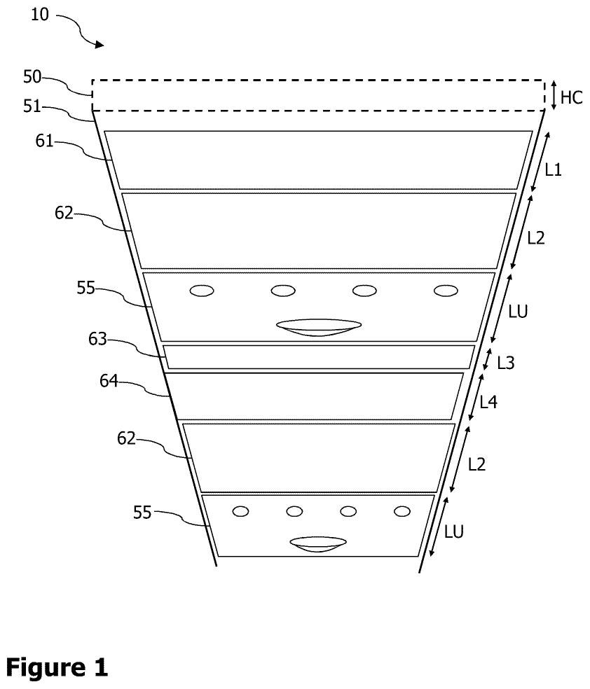

FIG. 1 schematically illustrates a conventional passenger supply system 10 comprising a passenger supply channel (PSC) 50. The PSC 50 is only schematically illustrated in dashed lines, and has a particular channel height HC. The PSC 50 has a bottom edge 51 on each side, which forms the lower limit of the channel height HC. The PSC 50 can be provided at an underside/bottom of a passenger cabin component, such as an overhead stowage compartment or a ceiling. Along a longitudinal direction of the PSC 50 there are several supply devices (not illustrated), such as fresh air ducts, electrical lines, oxygen supply, data lines, etc. At the bottom edge 51, for example, there can be an end (edge) of a lining of the overhead stowage compartment or a ceiling lining (not illustrated).

In accordance with the arrangement of a passenger seat or seat row (not illustrated), a passenger service unit (PSU) 55 is installed in the PSC 50. FIG. 1 illustrates two PSUs 55 in the PSC. Each PSU 55 has a length LU in the longitudinal direction of the PSC 50.

The gap between the adjacent PSUs 55 is conventionally closed by a plurality of infill panels 61, 62, 63, 64. Each of these infill panels 61-64 has a corresponding length L1, L2, L3, L4. As a mere example, three infill panels 63, 64, 62 are provided between the two illustrated PSUs 55, since the corresponding lengths L3, L4, L2 sum up to the length of the gap between the PSUs 55.

It often occurs that one or more infill panels 61-64, such as illustrated infill panel 64, may moves in a transverse direction orthogonal to the longitudinal direction, so that the outer edges of the infill panels 61-64 may not be flush, which deteriorates the aesthetic impression of the passenger supply system 10.

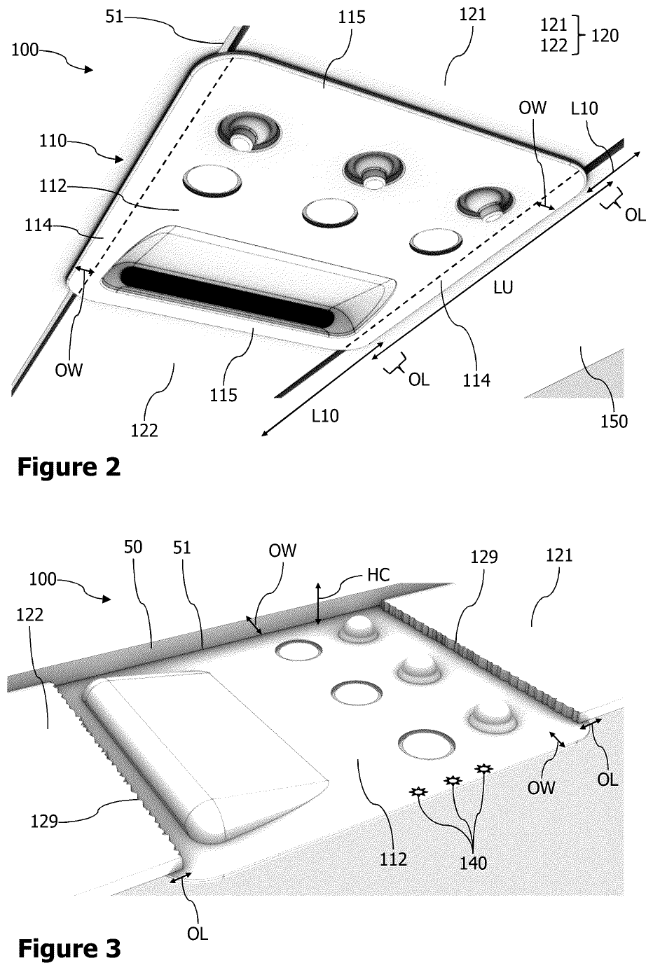

FIGS. 2 and 3 illustrate an exemplary passenger supply system 100 in a bottom view and top view, respectively (i.e., looking from a passenger area upwards and looking downwards from above a cut open PSC, respectively). The passenger supply system 100 comprises a passenger supply channel 50 (which can be a conventional PSC 50), a passenger service unit 110 configured to be mounted into the PSC 50, and an infill panel 120 also configured to be mounted into the PSC 50 (respectively adjacent infill panels 121 and 122 are together referred to as a general infill panel 120).

The passenger service unit 110 has a main body 112. A portion 115 of such main body 112 overlaps an end 129 of the infill panel 120. Specifically, when viewing in a longitudinal direction of the PSC 50, each end portion 115 of the main body 112 overlaps a longitudinal end 129 of the respective infill panel 121, 122. As is particularly illustrated in FIG. 3, the longitudinal end 129 of the infill panel 120 can be unmachined or raw, as it is not visible from the passenger side (cf. FIG. 2). This simplifies providing and installing the infill panel 120.

As a mere example, the length LU of the PSU 110 can be larger than a distance between the opposite longitudinal ends 129 of the respective infill panels 121, 122. The overlapping length OL may vary on both or either side of the PSU 110, since the length L10 of the infill panel 120 may not be a precise predefined length. This provides a lot of freedom when preparing the infill 120.

Furthermore, the passenger supply channel 50 faces downwards in a vertical direction and has a bottom edge 51. The portion 115 of the main body overlapping the infill panel 120 can be arranged below the bottom edge 51 of the PSC 50. This allows providing the infill panel 120 horizontally flush with the bottom edge 51 of the PSC 50, while the PSU 110 extends further downward. This allows the overlapping (OL) with the respective infill panels 121, 122.

As a mere example, the entire bottom portion of the main body 112 of the PSU 110 can be arranged below the bottom edge 51. Thus, the main body 112 can be provided with a plane bottom surface (cf. FIG. 2), which provides a neat appearance.

In the example of FIGS. 2 and 3, a circumference 114 of the main body 112 overlaps a first infill panel 121, a second infill panel 122 (opposite to the first infill panel 121) and the respective bottom edge 51 on both sides of the passenger supply channel 50. This allows a dedicated look/appearance of the PSU 110, while covering/overlapping not only the first and second infill panels 121, 122, but also the bottom edge 51 as well as any adjacent linings or the like (such as bottom lining of an overhead stowage compartment 150).

The overlapping width OW in the transverse direction of the PSC 50 may be the same as a maximum overlapping length OL in the longitudinal direction of the PSC 50. It is to be understood that the overlapping width OW can be chosen independent from the overlapping length OL, particularly, as the overlapping length OL depends on the length L10 of the infill panels 120.

The circumferential overlapping design of the PSU 110 further allows an illumination effect of the passenger supply system 100 in the vicinity of the passengers. Specifically, the passenger supply system 100 can comprise a light source 140 arranged at a top surface of the main body 112 (three light emitting elements 140 are illustrated in FIG. 3 as an example). Thus, any light emitted by the light source 140 is directed upwards (in a vertical direction), such as towards the overhead stowage compartment 150 and/or the infill panels 120. This allows illuminating the circumference 114 of the main body 112 or at least a portion thereof.

As a mere example, the main body 112 of the PSU 110 can be designed that it forms a small gap between the top surface of the main body 112 and any bottom surface of the overhead stowage compartment 150 and/or of the infill panels 120. This allows emitting light through this gap.

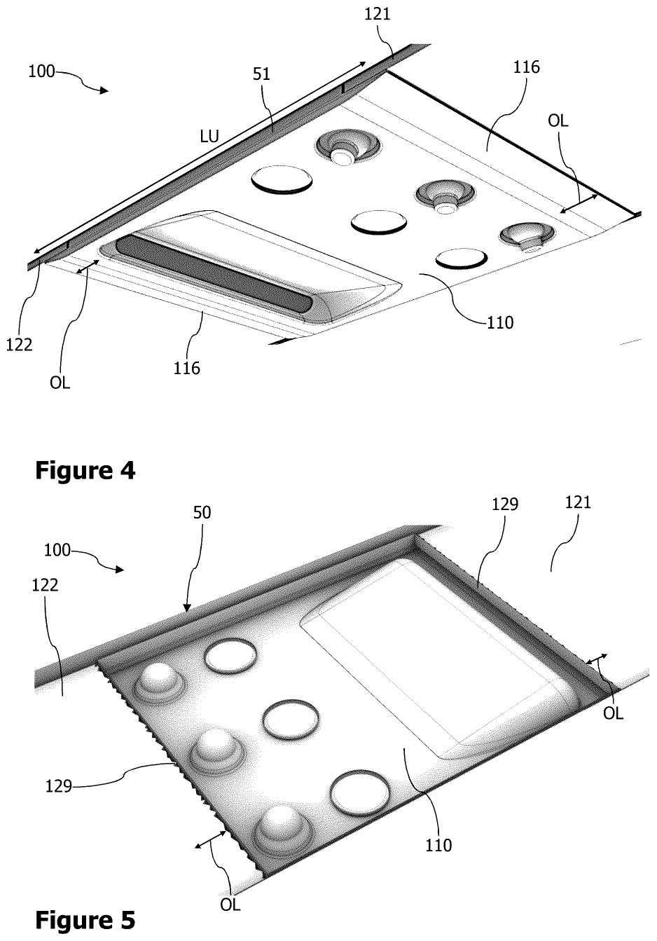

FIGS. 4 and 5 schematically illustrate another exemplary passenger supply system 100. Components and elements that are the same or have the same functionality as in the example of FIGS. 2 and 3 are provided with the same reference numeral. In order to avoid redundancies, the explanation of such components and elements is omitted, and only the differences between both exemplary passenger supply systems 100 is described.

As can be particularly seen in FIG. 4, the main body 112 has a portion 116 overlapping the infill panel 120 that is chamfered. Thus, in the area overlapping with the respective infill panel 121, 122, the chamfered portion 116 approaches the bottom surface of the infill panel 121, 122. This can achieve a look as if the PSU 110 is integrated into the longitudinally arranged infill panels 120. The chamfered portion 116 can have a length corresponding to the maximum overlapping length OL.

Furthermore, a width of the PSU 110 can be the same as a width of the infill panels 120. Both widths can be chosen to fill the PSC 50, i.e., to span between the opposite bottom edges 51 of the PSC 50. This allows installing the passenger supply system 100 with continuous edges of the infill panels 120 and the PSUs 110, which are parallel and equidistant to any edges of adjacent linings or the like.

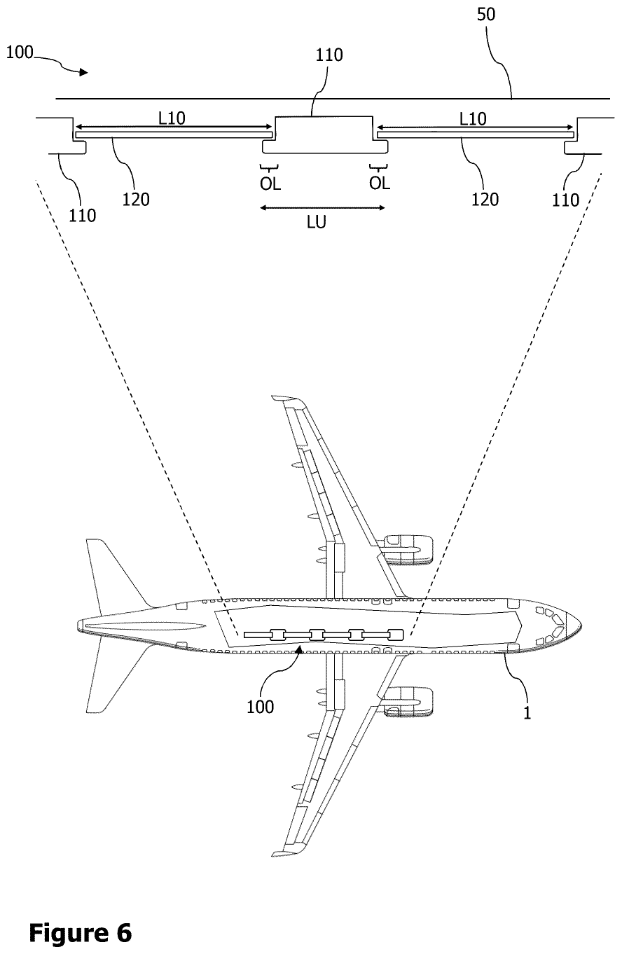

FIG. 6 schematically illustrates an aircraft 1 comprising at least one passenger supply system 100. Furthermore, FIG. 6 illustrates a cross-section cut along the longitudinal direction and viewing in a transverse direction of the passenger supply system 100.

The disclosed passenger supply system 100 allows provision of only a single (type) infill panel 120, which reduces the effort of certifying such internal aircraft components and reduces the number of parts to be provided for installing interior cabin components. Thus, manufacturing and planning of cabin structures can be simplified.

The single infill panel 120 can be provided with a standard length, which is then cut to a length L10 required in the particular aircraft 1. Thus, depending on the longitudinal distance between adjacent passenger seats or seat rows, the distance between the PSUs 110 can be determined and the infill panels 120 can be cut to the required length L10. The cut edge (at end 129) will be covered by the PSUs 110, so that no finishing or machining is required.

It is believed that the advantages of the technique presented herein will be fully understood from the foregoing description, and it will be apparent that various changes may be made in the form, constructions and arrangement of the exemplary aspects thereof without departing from the scope of the disclosure or without sacrificing all of its advantageous effects. Because the technique presented herein can be varied in many ways, it will be recognized that the disclosure should be limited only by the scope of the claims that follow.

The systems and devices described herein may include a controller or a computing device comprising a processing unit and a memory which has stored therein computer-executable instructions for implementing the processes described herein. The processing unit may comprise any suitable devices configured to cause a series of steps to be performed so as to implement the method such that instructions, when executed by the computing device or other programmable apparatus, may cause the functions/acts/steps specified in the methods described herein to be executed. The processing unit may comprise, for example, any type of general-purpose microprocessor or microcontroller, a digital signal processing (DSP) processor, a central processing unit (CPU), an integrated circuit, a field programmable gate array (FPGA), a reconfigurable processor, other suitably programmed or programmable logic circuits, or any combination thereof.

The memory may be any suitable known or other machine-readable storage medium. The memory may comprise non-transitory computer readable storage medium such as, for example, but not limited to, an electronic, magnetic, optical, electromagnetic, infrared, or semiconductor system, apparatus, or device, or any suitable combination of the foregoing. The memory may include a suitable combination of any type of computer memory that is located either internally or externally to the device such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. The memory may comprise any storage means (e.g., devices) suitable for retrievably storing the computer-executable instructions executable by processing unit.

The methods and systems described herein may be implemented in a high-level procedural or object-oriented programming or scripting language, or a combination thereof, to communicate with or assist in the operation of the controller or computing device. Alternatively, the methods and systems described herein may be implemented in assembly or machine language. The language may be a compiled or interpreted language. Program code for implementing the methods and systems described herein may be stored on the storage media or the device, for example a ROM, a magnetic disk, an optical disc, a flash drive, or any other suitable storage media or device. The program code may be readable by a general or special-purpose programmable computer for configuring and operating the computer when the storage media or device is read by the computer to perform the procedures described herein.

Computer-executable instructions may be in many forms, including modules, executed by one or more computers or other devices. Generally, modules include routines, programs, objects, components, data structures, etc., that perform particular tasks or implement particular abstract data types. Typically, the functionality of the modules may be combined or distributed as desired in various embodiments.

It will be appreciated that the systems and devices and components thereof may utilize communication through any of various network protocols such as TCP/IP, Ethernet, FTP, HTTP and the like, and/or through various wireless communication technologies such as GSM, CDMA, Wi-Fi, and WiMAX, is and the various computing devices described herein may be configured to communicate using any of these network protocols or technologies.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A passenger supply system for an aircraft, comprising:
a passenger supply channel;
a passenger service unit having a main body, wherein the passenger service unit is configured to be mounted into the passenger supply channel; and
an infill panel configured to be mounted into the passenger supply channel,
wherein a portion of the main body of the passenger service unit overlaps an end of the infill panel.

2. The passenger supply system of claim 1, wherein the passenger supply channel faces downwards in a vertical direction and has a bottom edge, and,
wherein the portion of the main body overlapping the infill panel is arranged below the bottom edge of the passenger supply channel, or
wherein an entire bottom portion of the main body of the passenger service unit is arranged below the bottom edge, or both.

3. The passenger supply system of claim 2, wherein a circumference of the main body overlaps a first infill panel, a second infill panel, and the bottom edge on two sides of the passenger supply channel.

4. The passenger supply system of claim 1, wherein the portion of the main body overlapping the infill panel is chamfered.

5. The passenger supply system of claim 1, further comprising:
a light source arranged at a top surface of the main body.

6. The passenger supply system of claim 5, wherein, the light source indicates a passenger call.

7. The passenger supply system of claim 1, further comprising:
a further passenger service unit mounted in the passenger supply channel at a distance, in a longitudinal direction, from the passenger supply channel,
wherein the infill panel has a length in the longitudinal direction of the passenger supply channel corresponding to the distance between the passenger service units.

8. The passenger supply system of claim 7, wherein a longitudinal end of the infill panel is machined after cutting the infill panel to have the length.

9. The passenger supply system of claim 1, wherein the infill panel comprises an extruded profile.

10. An aircraft, comprising:
at least one passenger supply system of claim 1.

11. The aircraft of claim 10, further comprising:
a plurality of overhead stowage compartments,
wherein the passenger supply channel of the at least one passenger supply system is arranged at a bottom of the plurality of overhead stowage compartments.
